(19) United States
(12) Patent Application Publication
(10) Pub. No.: US 2014/0177281 A1
(43) Pub. Date: Jun. 26, 2014

(54) POWER CONVERTING SYSTEM AND CONTROL METHOD THEREOF

(71) Applicants: Yen-Shin Lai, Taipei (TW); Yi-Jan Chang, Pingzhen City (TW)

(72) Inventors: Yen-Shin Lai, Taipei (TW); Yi-Jan Chang, Pingzhen City (TW)

(21) Appl. No.: 13/831,278

(22) Filed: Mar. 14, 2013

(30) Foreign Application Priority Data
Dec. 26, 2012 (TW) 101150278

(51) Int. Cl. H02M 3/335

(52) U.S. Cl. CPC H02M 3/33507
USPC 363/17

(57) ABSTRACT

A power converting system includes a full-bridge converter and a controlling unit. The full-bridge converter includes two switch elements at a first leg and two switch elements at a second leg. The controlling unit is in communication with the full-bridge converter for generating two leading control signals to control the first leg and two lagging control signals to control the second leg in a first modulation mode, or generating the two leading control signals to control the second leg and the two lagging control signals to control the first leg in a second modulation mode. The first modulation mode and the second modulation mode are alternately switched between each other, or randomly switched between each other or adaptively switched between each other according to a temperature difference between the first leg and the second leg.

### FIELD OF THE INVENTION

The present invention relates to a power converting system and a control method thereof, and more particularly to a phase-shift full-bridge power converting system and a control method thereof.

### BACKGROUND OF THE INVENTION

Nowadays, with increasing awareness of global warming problems, more and more products are designed in views of power-saving concepts. For example, since a switching power converter has increased converting efficiency and reduced volume, the manufacturers pay much attention to the development of the switching power converter. As known, temperature is an important factor influencing the performance of the power converter. The life and safety of the power converter are influenced by the temperature. Consequently, for designing a power converter, the heat-dissipating mechanism and the heat flow path should be taken into consideration. Moreover, the switch element usually has the highest temperature among all electronic components of a high-power switching power converter. Due to the non-ideal characteristics of the switch element, the on/off loss and the conduction loss are increased. The on/off loss and the conduction loss may be transformed into heat. For removing the heat, a large heat sink is required to reduce the temperature.

FIG. 1 is a schematic circuit diagram of a conventional power converting system. FIG. 2 is a schematic waveform diagram illustrating associated switch control signals of the conventional power converting system. The conventional power converting system comprises a full-bridge converter 21 and a controlling unit 22. Since the full-bridge converter 21 is operated in a zero voltage switching (ZVS) manner, the converting efficiency is high. Consequently, the full-bridge converter 21 is widely used in the electronic industry. The controlling unit 22 is in communication with the full-bridge converter 21. The full-bridge converter 21 is used for converting an input voltage V_{IN} into an output voltage V_{OUT}. The full-bridge converter 21 comprises a drive unit 210, two switch elements Q1, Q2 at a leading leg 211, two switch elements Q3, Q4 at a lagging leg 212, a transformer Tr, an inductor Lr, a secondary-side rectifying circuit 213, and an output filter 214. The four switch elements Q1, Q2, Q3 and Q4 are driven by the drive unit 210. The inductor Lr is connected with the leading leg 211 and the transformer Tr. The secondary-side rectifying circuit 213 is connected with the secondary side of the transformer Tr. The output filter 214 is connected with the secondary-side rectifying circuit 213. The switch elements Q1 and Q2 at the leading leg 211 are driven at a fixed 50% duty cycle. That is, the conduction time is equal to 0.5 Ts, wherein Ts is the switching period. There is time difference DTs between the leading control signals for controlling the leading leg 211 and the lagging control signals for controlling the lagging leg 212. Since the switch elements of the leading leg 211 and the switch elements of the lagging leg 212 are not simultaneously conducted or shut off, the conditions to achieve ZVS are different. Generally, the current for the leading leg 211 to achieve ZVS is much higher than that for the lagging leg 212. Consequently, the lagging leg 212 can achieve ZVS easier than the leading leg 211. In other words, the switching loss for the leading leg 211 is higher. It is found that the temperature of the leading leg 211 is usually higher than the temperature of the lagging leg 212.

From the above discussions, the conventional power converting system still has some drawbacks that need to be overcome.

In order to obviate the above drawbacks, the applicant keeps on carving unflaggingly to develop a phase-shift full-bridge power converting system and a control method thereof through wholehearted experience and research.

### SUMMARY OF THE INVENTION

The present invention provides a phase-shift full-bridge power converting system and a control method thereof. The power converting system comprises a full-bridge converter and a controlling unit. By using the controlling unit to control the operations of the full-bridge converter, the efficacy of balancing the temperature of the two legs of the full-bridge converter is enhanced.

In accordance with an aspect of the present invention, there is provided a power converting system. The power converting system includes a full-bridge converter and a controlling unit. The full-bridge converter includes two switch elements at a first leg and two switch elements at a second leg. The controlling unit is in communication with the full-bridge converter for generating two leading control signals to control the first leg and two lagging control signals to control the second leg in a first modulation mode, or generating the two leading control signals to control the second leg and the two lagging control signals to control the first leg in a second modulation mode. The first modulation mode and the second modulation mode are alternately switched between each other, or randomly switched between each other or adaptively switched between each other according to a temperature difference between the first leg and the second leg.

In accordance with another aspect of the present invention, there is provided a control method for controlling a power converting system. The power converting system includes a full-bridge converter with two switch elements at a first leg and two switch elements at a second leg. The control method includes the following steps. In a first modulation mode, two leading control signals and two lagging control signals are generated to control the first leg and the second leg, respectively. In a second modulation mode, the two leading control signals and the two lagging control signals are generated to control the second leg and the first leg, respectively. Moreover, a first select signal or a second select signal is selectively generated. The first modulation mode is switched to the second modulation mode in response to a first select signal, and the second modulation mode is switched to the first modulation mode in response to the second select signal.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic circuit diagram of a conventional power converting system;

FIG. 2 is a schematic waveform diagram illustrating associated switch control signals of the conventional power converting system;

FIG. 3 is a schematic circuit diagram illustrating a power converting system according to an embodiment of the present invention;

FIG. 4 is a schematic functional block diagram illustrating the closed-loop control architecture of the power converting system of FIG. 3;

FIG. 5 is a schematic waveform diagram illustrating associated switch control signals of the power converting system of the present invention, in which Q1 and Q2 are controlled by the lagging control signals and Q3 and Q4 are controlled by the leading control signals;

FIG. 6 is a schematic functional block diagram illustrating the open-loop control architecture of the power converting system of FIG. 3;

FIG. 7 schematically illustrates a first exemplary modulation mode selector used in the power converting system of the present invention;

FIG. 8 schematically illustrates a second exemplary modulation mode selector used in the power converting system of the present invention;

FIG. 9A schematically illustrates a third exemplary modulation mode selector used in the power converting system of the present invention; and

FIG. 9B is a schematic hysteresis loop showing the relation between the select signal and the temperature difference ΔT.

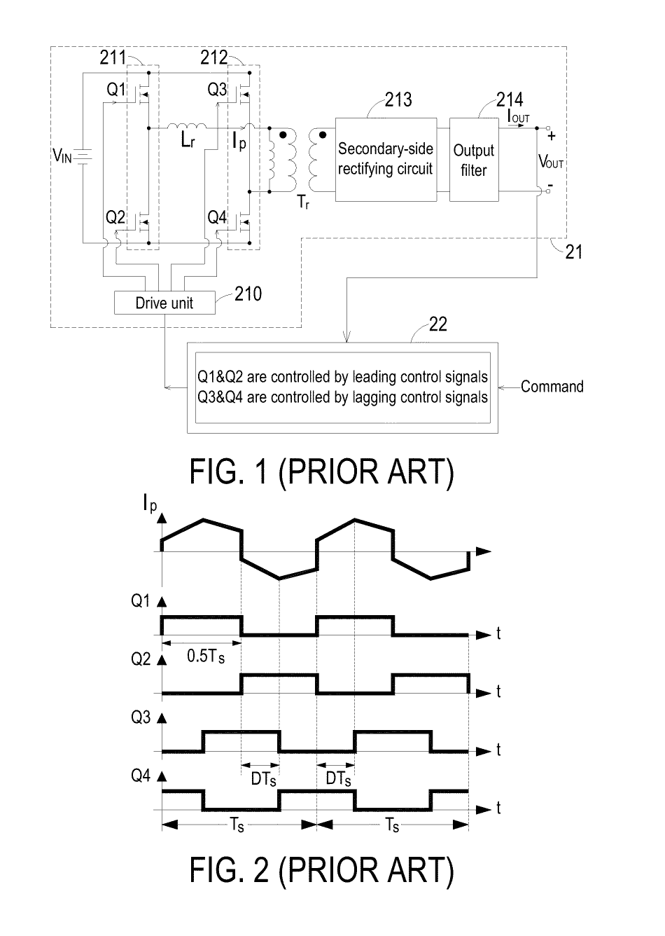

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

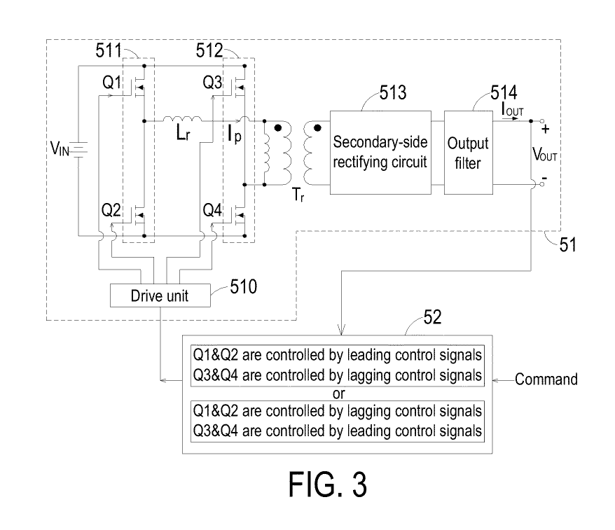

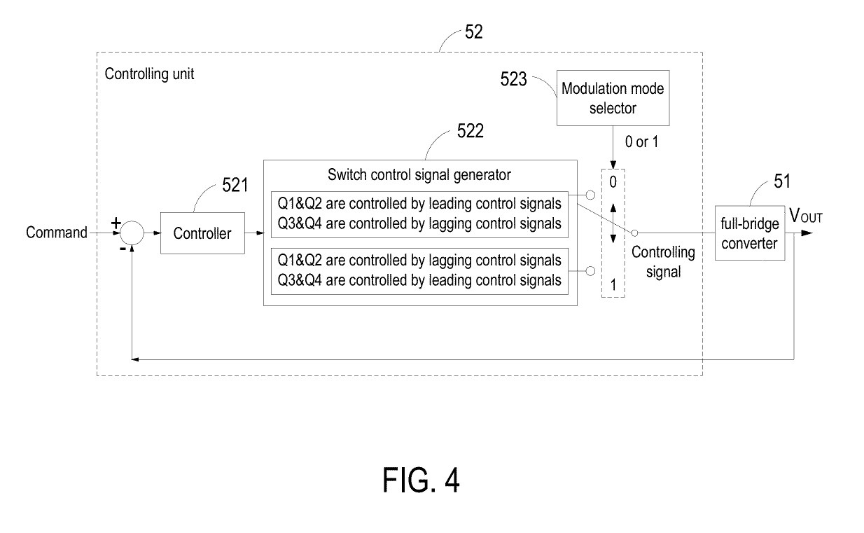

FIG. 3 is a schematic circuit diagram illustrating a power converting system according to an embodiment of the present invention. FIG. 4 is a schematic functional block diagram illustrating the closed-loop control architecture of the power converting system of FIG. 3.

As shown in FIGS. 3 and 4, the power converting system is a phase-shift full-bridge power converting system, and comprises a full-bridge converter 51 and a controlling unit 52. The controlling unit 52 is in communication with the full-bridge converter 51. The full-bridge converter 51 is used for converting an input voltage V_{IN} into an output voltage V_{OUT}. The full-bridge converter 51 comprises a drive unit 510, two switch elements Q1, Q2 at a first leg 511, two switch elements Q3, Q4 at a second leg 512, a transformer Tr, an inductor Lr, a secondary-side rectifying circuit 513, and an output filter 514. The four switch elements Q1, Q2, Q3 and Q4 are driven by the drive unit 510. The inductor Lr is connected with the first leg 511 and the transformer Tr. In an embodiment, the inductor Lr is a leakage inductor. The secondary-side rectifying circuit 513 is connected with the secondary side of the transformer Tr. The output filter 514 is connected with the secondary-side rectifying circuit 513.

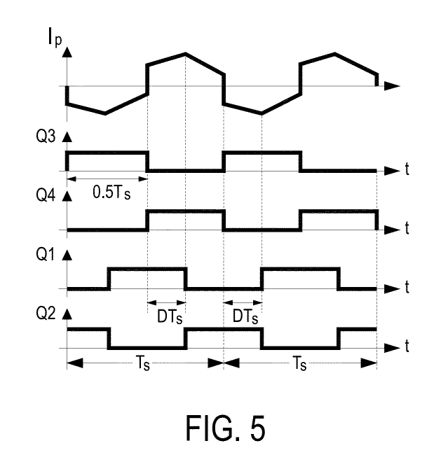

The controlling unit 52 is electrically connected with the full-bridge converter 51. The controlling unit 52 comprises a controller 521, a switch control signal generator 522, and a modulation mode selector 523. After the output voltage V_{OUT} from the full-bridge converter 51 is compared with a command (e.g. a command voltage), a voltage error is obtained. According to the voltage error, the controller 521 generates a required duty cycle. According to the duty cycle, the switch control signal generator 522 generates the switch control signals. In this embodiment, the switch control signals comprise two leading control signals and two lagging control signals. According to a select signal outputted from the modulation mode selector 523, the switch control signals corresponding to the selected modulation mode are outputted to the full-bridge converter 51 in order to control the on/off states of the switch elements Q1, Q2 of the first leg 511 and the switch elements Q3, Q4 of the second leg 512 of the full-bridge converter 51. For example, in a case where the select signal generated by the modulation mode selector 523 is “0”, the leading control signals and the lagging control signals corresponding to the first modulation mode are outputted to the full-bridge converter 51. Consequently, the switch elements Q1 and Q2 of the first leg 511 are controlled by the leading control signals of the switch control signals, and the switch elements Q3 and Q4 of the second leg 512 are controlled by the lagging control signals of the switch control signals. In other words, the waveforms of the switch control signals corresponding to the first modulation mode are similar to those of FIG. 2. On the other hand, in a case where the select signal outputted from the modulation mode selector 523 is “1”, the leading control signals and the lagging control signals corresponding to the second modulation mode are outputted to the full-bridge converter 51. Consequently, the switch elements Q1 and Q2 of the first leg 511 are controlled by the lagging control signals of the switch control signals, and the switch elements Q3 and Q4 of the second leg 512 are controlled by the leading control signals of the switch control signals. In other words, the waveforms of the switch control signals corresponding to the second modulation mode are similar to those of FIG. 5.

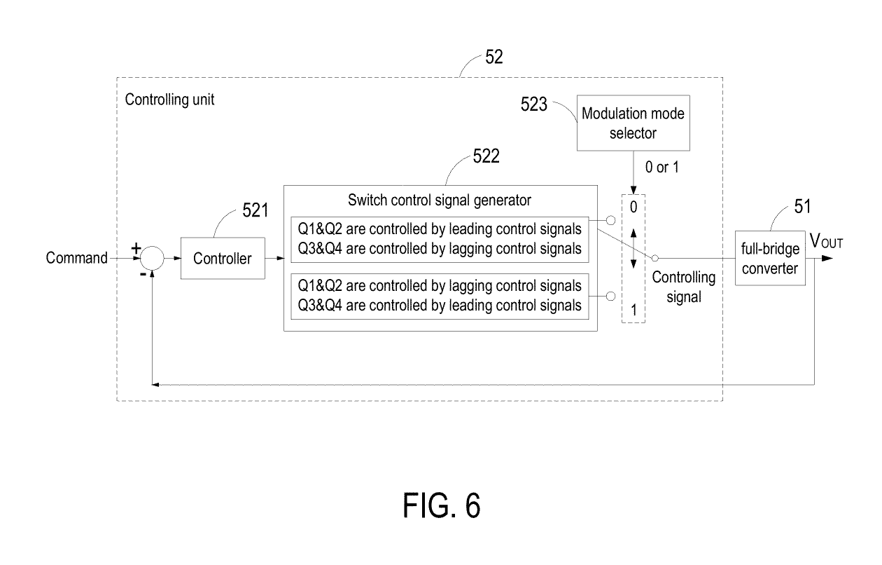

FIG. 6 is a schematic functional block diagram illustrating the open-loop control architecture of the power converting system of FIG. 3. Please refer to FIGS. 3 and 6. According to a command, the controller 521 generates a required duty cycle. According to the duty cycle, the switch control signal generator 522 generates the switch control signals. In this embodiment, the switch control signals comprise two leading control signals and two lagging control signals. According to a select signal outputted from the modulation mode selector 523, the switch control signals corresponding to the selected modulation mode are outputted to the full-bridge converter 51 in order to control the on/off states of the switch elements Q1, Q2 of the first leg 511 and the switch elements Q3, Q4 of the second leg 512 of the full-bridge converter 51. For example, in a case where the select signal outputted from the modulation mode selector 523 is “0”, the switch elements Q1 and Q2 of the first leg 511 are controlled by the leading control signals of the switch control signals, and the switch elements Q3 and Q4 of the second leg 512 are controlled by the lagging control signals of the switch control signals. In other words, the waveforms of the switch control signals corresponding to the first modulation mode are similar to those of FIG. 2. On the other hand, in a case where the select signal outputted from the modulation mode selector 523 is “1”, the switch elements Q1 and Q2 of the first leg 511 are controlled by the lagging control signals of the switch control signals, and the switch elements Q3 and Q4 of the second leg 512 are controlled by the leading control signals of the switch control signals. In other words, the waveforms of the switch control signals corresponding to the second modulation mode are similar to those of FIG. 5.

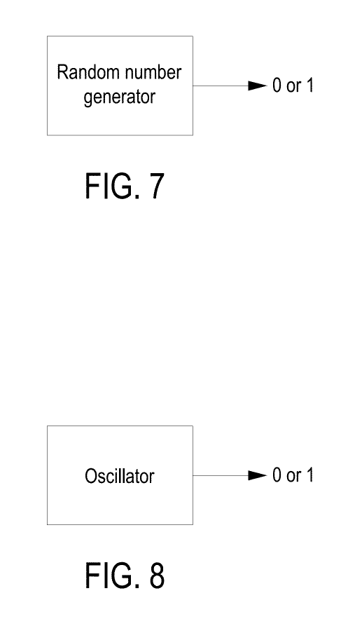

Hereinafter, some examples of the modulation mode selector 523 will be illustrated with reference to FIGS. 7, 8 and 9.

FIG. 7 schematically illustrates a first exemplary modulation mode selector used in the power converting system of the present invention. In this embodiment, the modulation mode selector is a random number generator for randomly generating the select signal “0” or “1”. The operating principles and the configurations of the random number generator are well known to those skilled in the art, and are not redundantly described herein. In a case where the select signal outputted from the random number is “0”, the waveforms of the switch control signals are similar to those of FIG. 2. Whereas, in a case where the select signal outputted from the random number is “1”, the waveforms of the switch control signals are similar to those of FIG. 5. Since the select signal “0” or “1” is generated randomly, the modulation mode is randomly switched between the first modulation mode and the second modulation mode. In this context, the way of controlling the modulation mode to be randomly switched between the first modulation mode and the second modulation mode is also referred as a random control method.

FIG. 8 schematically illustrates a second exemplary modulation mode selector used in the power converting system of the present invention. In this embodiment, the modulation mode selector is an oscillator for generating the select signal “0” or “1” in a repetitive and oscillating manner. The operating principles and the configurations of the oscillator are well known to those skilled in the art, and are not redundantly described herein. In a case where the select signal outputted from the random number is “0”, the waveforms of the switch control signals are similar to those of FIG. 2. Whereas, in a case where the select signal outputted from the random number is “1”, the waveforms of the switch control signals are similar to those of FIG. 5. Since the select signal “0” or “1” is generated in a repetitive and oscillating manner, the modulation mode is alternatively and periodically switched between the first modulation mode and the second modulation mode. In this context, the way of controlling the modulation mode to be alternatively switched between the first modulation mode and the second modulation mode is also referred as an alternating control method.

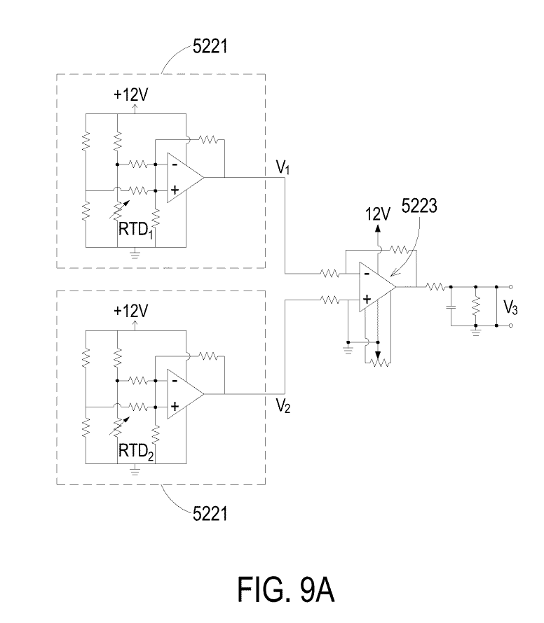

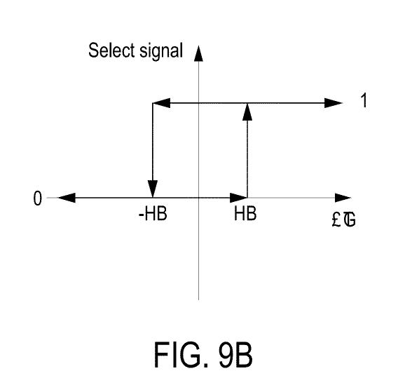

FIG. 9A schematically illustrates a third exemplary modulation mode selector used in the power converting system of the present invention. In this embodiment, the modulation mode selector is a temperature feedback circuit for generating the select signal “0” or “1” according to a temperature difference between the first leg 511 and the second leg 512. The temperature feedback circuit comprises a first differential amplifier 5221, a second differential amplifier 5222, and a third differential amplifier 5223. The first differential amplifier 5221 has a first resistance temperature detector RTD1. The second differential amplifier 5222 has a second resistance temperature detector RTD2. The resistance of the first resistance temperature detector RTD1 reflects the temperature of the first leg 511. The resistance of the second differential amplifier 5222 reflects the temperature of the second leg 512. Generally, as temperature increases, the resistance value of the resistance temperature detector decreases. According to the temperature of the first leg 511 and the temperature of the second leg 512, a first voltage V1 is outputted from the first differential amplifier 5221 and a second voltage V2 is outputted from the second differential amplifier 5222. The first voltage V1 and the second voltage V2 are inputted into two input terminals of the third differential amplifier 5223, respectively. According to the first voltage V1 and the second voltage V2, a third voltage V3 is outputted from the third differential amplifier 5223. The third voltage V3 reflects the temperature difference AT between the second leg 512 and the first leg 511. If the temperature of the second leg 512 is higher than the first leg 511, the third voltage V3 increases, and vice versa. According to the third voltage V3, the select signal “0” or “1” is correspondingly generated. If the temperature of the first leg 511 minus the temperature of the second leg 512 is higher than a threshold temperature difference HB (e.g. 5° C.), the temperature feedback circuit generates the select signal “1”. If the temperature of the first leg 511 minus the temperature of the second leg 512 is lower than −HB (e.g. −5° C.), the temperature feedback circuit generates the select signal “0”. If the temperature of the first leg 511 minus the temperature of the second leg 512 is in the range between −HB (e.g. −5° C.) and HB (e.g. 5° C.), a hysteresis loop between the select signal and the temperature difference ΔT is generated. FIG. 9B is a schematic hysteresis loop showing the relation between the select signal and the temperature difference ΔT. If the initial modulation mode is the first modulation mode, the first modulation mode is switched to the second modulation mode (i.e. select signal is “1”) when the temperature difference AT is larger than 5° C. If the initial modulation mode is the second modulation mode, the second modulation mode (i.e. select signal is “0”) is switched to the first modulation mode when the temperature difference AT is lower than −5° C. In this context, the way of controlling the modulation mode to be switched between the first modulation mode and the second modulation mode according to the temperature difference is also referred as a temperature control method.

For realizing the thermal balance efficacy of the control method of the present invention, some experiments are carried out. The full-bridge converter is operated in the following test conditions: the input voltage is 400V, the output voltage is 12V, and the power rating is 600W. Before the tests are carried out, the temperature of the switch elements Q1, Q2, Q3 and Q4 is 25° C. After the tests have been performed for 5 minutes, an infrared camera is used to record the thermal images. When the conventional control method is used, the temperature of the first leg is 44.3° C. and the temperature of the second leg is 36.2° C. (i.e. ΔT=8.1° C.). When the random control method is used, the temperature of the first leg is 40.3° C. and the temperature of the second leg is 43.4° C. (i.e. ΔT=3.1° C.). When the alternating control method is used, the temperature of the first leg is 40.0° C. and the temperature of the second leg is 44.9° C. (i.e. ΔT=4.9° C.). When the temperature control method is used, the temperature of the first leg is 45.0° C. and the temperature of the second leg is 44.9° C. (i.e. ΔT=0.1° C.). From the above experiments, it is found that a significant thermal imbalance exists between the two legs of the full-bridge converter by the conventional control method. Moreover, the random control method and the alternating control method can reduce the thermal imbalance. Moreover, the temperature control method provides a good thermal balance result.

From the above description, the present invention provides a phase-shift full-bridge power converting system and a control method thereof. The power converting system comprises a full-bridge converter and a controlling unit. The switch control signals corresponding to the first modulation mode and the switch control signals corresponding to the second modulation mode are alternately outputted to the full-bridge converter in order to control the on/off states of the first leg and the second leg of the full-bridge converter. Consequently, the temperature of the switch elements of the first leg and the temperature of the switch elements of the second leg can be easily balanced. In other words, the thermal balance efficacy of using the power converting system of the present invention is enhanced when compared with the conventional power converting system.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power converting system, comprising:
a full-bridge converter comprising two switch elements at a first leg and two switch elements at a second leg; and
a controlling unit in communication with said full-bridge converter for generating two leading control signals to control said first leg and two lagging control signals to control said second leg in a first modulation mode, or generating said two leading control signals to control said second leg and said two lagging control signals to control said first leg in a second modulation mode, wherein said first modulation mode and said second modulation mode are alternately switched between each other, or randomly switched between each other or adaptively switched between each other according to a temperature difference between said first leg and said second leg.

2. The power converting system according to claim 1, wherein said controlling unit comprises a controller for generating a duty cycle.

3. The power converting system according to claim 2, wherein said controlling unit further comprises a switch control signal generator for generating said two leading control signals and said two lagging control signals according to said duty cycle.

4. The power converting system according to claim 3, wherein said controlling unit further comprises a modulation mode selector for generating a select signal, wherein according to said select signal, said two leading control signals and said two lagging control signals corresponding to said first modulation mode or said second modulation mode are outputted to said full-bridge converter.

5. The power converting system according to claim 4, wherein if said select signal is “0”, said two leading control signals and said two lagging control signals corresponding to said first modulation mode are outputted to said full-bridge converter to control said first leg and said second leg, respectively, wherein if said select signal is “1”, said two leading control signals and said two lagging control signals corresponding to said second modulation mode are outputted to said full-bridge converter to control said second leg and said first leg, respectively.

6. The power converting system according to claim 5, wherein said modulation mode selector is a random number generator for randomly generating said select signal “0” or “1”.

7. The power converting system according to claim 5, wherein said modulation mode selector is an oscillator for generating said select signal “0” or “1” in a repetitive and oscillating manner.

8. The power converting system according to claim 5, wherein said modulation mode selector is a temperature feedback circuit for generating said select signal “0” or “1” according to said temperature difference between said first leg and said second leg.

9. The power converting system according to claim 1, wherein said power converting system further comprises:
a drive unit for driving said two switch elements at said first leg and said two switch elements at said second leg;
a transformer;
an inductor connected with said first leg and said transformer;
a secondary-side rectifying circuit connected with a secondary side of said transformer; and
an output filter connected with said secondary-side rectifying circuit.

10. The power converting system according to claim 9, wherein said inductor is a leakage inductor of said transformer.

11. A control method for controlling a power converting system, said power converting system comprising a full-bridge converter with two switch elements at a first leg and two switch elements at a second leg, said control method comprising steps of:
generating two leading control signals and two lagging control signals to control said first leg and said second leg, respectively, in a first modulation mode;
generating said two leading control signals and said two lagging control signals to control said second leg and said first leg, respectively, in a second modulation mode; and
selectively generating a first select signal or a second select signal, wherein said first modulation mode is switched to said second modulation mode in response to a first select signal, and said second modulation mode is switched to said first modulation mode in response to said second select signal.

12. The control method according to claim 11, wherein said first select signal and said second select signal are alternately and periodically generated.

13. The control method according to claim 11, wherein said first select signal or said second select signal is randomly generated.

14. The control method according to claim 11, wherein said first select signal or said second select signal is generated according to a temperature difference between said first leg and said second leg.
